(19) United States
(12) Patent Application Publication
(10) Pub. No.: US 2016/0198090 A1
(43) Pub. Date: Jul. 7, 2016

(54) Camera and A Method for Controlling a State Machine of the Camera Thereof

(71) Applicant: GoBe Cam Limited, Taipei City (TW)

(72) Inventor: Zhou Ye, Taipei (TW)

(21) Appl. No.: 14/616,823

(22) Filed: Feb. 9, 2015

(30) Foreign Application Priority Data
Jan. 5, 2015 (CN) 201510001979.9

(51) Int. Cl. H04N 5/232; H04N 5/225

(52) U.S. Cl. CPC H04N 5/23241; H04N 5/2256

(57) ABSTRACT

A method for controlling a state machine of a camera is provided. The method includes steps: controlling the state machine of the camera according to a continuously-pressed number of a button of the camera; when the state machine of the camera is in an OFF state and the continuously-pressed number of the button is one, performing a booting process to make the state machine of the camera to be switched from the OFF state into an ON state; and when the state machine of the camera is in the ON state and the continuously-pressed number of the button is two, performing a shutdown process to make the state machine of the camera to be switched from the ON state into the OFF state. By using the flashing LED to control the method, the state machine of the camera can be clearly known by the user to provide more convenient manipulation.

### BACKGROUND OF THE INVENTION

1. Field of the Invention

The present disclosure relates to a method for controlling a state machine of a camera, and more particularly, to a camera and a method for controlling a state machine of the camera according to a continuously-pressed number of a button of the camera thereof.

2. Description of the Prior Art

At present, for a conventional camera, a user usually needs to operate a screen of the camera in order to understand the stat machine of the camera. However, once one camera does not equipped with a screen, it will be difficult for the user to clearly understand the state machine of the camera.

Hence, how to overcome the design issue of the camera to make the user easily control and understand the state machine of the camera has become an important topic in this field.

### SUMMARY OF THE INVENTION

It is therefore one of the objectives of the present disclosure to provide a camera and a method for controlling a state machine of the camera according to a continuously-pressed number of a button of the camera to solve the above-mentioned problems in the prior art.

According to one aspect of the present disclosure, a method for controlling a state machine of a camera is provided. The method includes the following steps: controlling a state machine of the camera according to a continuously-pressed number of a button of the camera; when the state machine of the camera is in an OFF state and the continuously-pressed number of the button is one, performing a booting process to make the state machine of the camera to be switched from the OFF state into an ON state; and when the state machine of the camera is in the ON state and the continuously-pressed number of the button is two, performing a shutdown process to make the state machine of the camera to be switched from the ON state into the OFF state.

According to one aspect of the present disclosure, the method further includes the following step: when the camera is performing the booting process, controlling a green LED to flash.

According to one aspect of the present disclosure, a camera is provided. The camera includes a button and a processor. The processor is configured for controlling state machine of the camera according to a continuously-pressed number of the button of the camera; when the state machine of the camera is in an OFF state and the continuously-pressed number of the button is one, performing a booting process to make the state machine of the camera to be switched from the OFF state into an ON state; and when the state machine of the camera is in the ON state and the continuously-pressed number of the button is two, performing a shutdown process to make the state machine of the camera to be switched from the ON state into the OFF state.

By adopting the present disclosure, the state machine of the camera can be controlled by using the continuously-pressed number of the button of the camera. Additionally, by using and controlling the LED(s) to collocate with the method, the state machine of the camera can be clearly known by the user.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram showing a camera capable of controlling a state machine according to an embodiment of the present disclosure.

FIG. 2 is a flowchart illustrating a method for controlling a state machine of a camera according to a first embodiment of the present disclosure.

FIG. 3 is a flowchart illustrating a method for controlling a state machine of a camera according to a second embodiment of the present disclosure.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

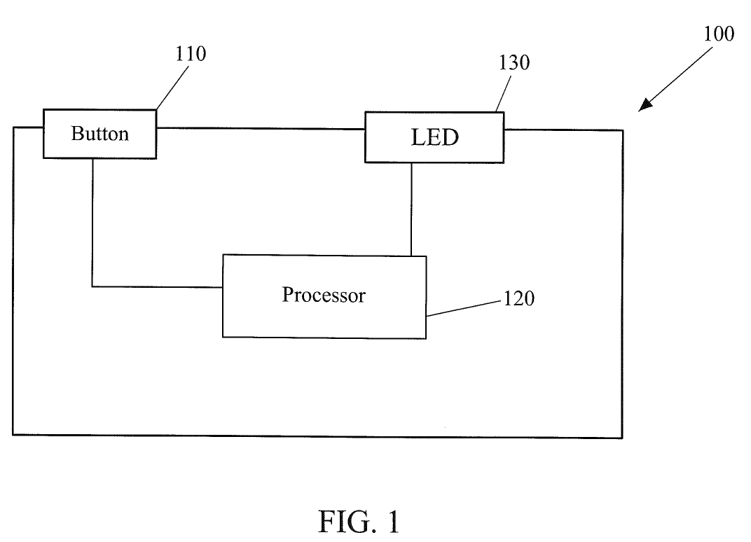

Please refer to FIG. 1. FIG. 1 is a block diagram showing a camera 100 capable of controlling a state machine according to an embodiment of the present disclosure. As shown in FIG. 1, the camera 100 may include, but is not limited to, a button 110, a processor 120, and at least one Light-emitting Diode (LED) 130. Be noted that, the camera 100 is capable of controlling the state machine of the camera 100 according to a continuously-pressed number of a button 110. The button 110 may be a power button of the camera 100, however, this should not be a limitation of the present disclosure. The LED 130 may include a green LED, a yellow LED, or both, or LEDs of other colors.

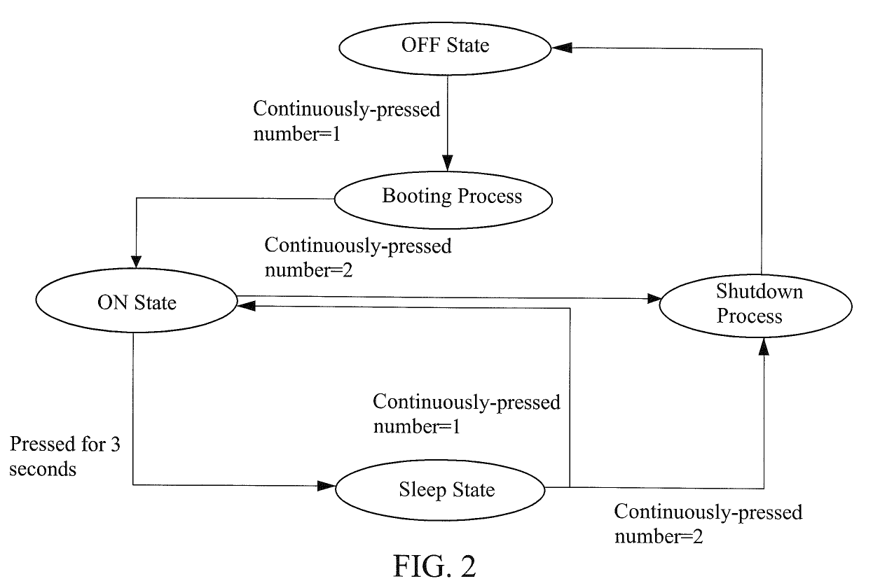

Please refer to FIG. 2. FIG. 2 is a flowchart illustrating a method for controlling a state machine of a camera according to a first embodiment of the present disclosure. As shown in FIG. 2, when the state machine of the camera 100 is in an OFF state and the continuously-pressed number of the button 110 is one, the camera 100 performs a booting process to make the state machine of the camera 100 to be switched from the OFF state into an ON state. Additionally, when the state machine of the camera 100 is in the ON state and the continuously-pressed number of the button 110 is two, the camera 100 performs a shutdown process to make the state machine of the camera 100 to be switched from the ON state into the OFF state. Furthermore, when the state machine of the camera 100 is in the ON state, and the continuously-pressed number of the button 110 is one and the button 110 is pressed for 3 seconds, the state machine of the camera 100 is switched from the ON state into a sleep state. What calls for special attention is that, when the state machine of the camera 100 is in the sleep state and the continuously-pressed number of the button 110 is one, the state machine of the camera 100 is switched from the sleep state into the ON state. In another embodiment, when the state machine of the camera 100 is in the sleep state and the continuously-pressed number of the button 110 is two, the camera 100 performs the shutdown process to make the state machine of the camera 100 to be switched from the sleep state into the OFF state.

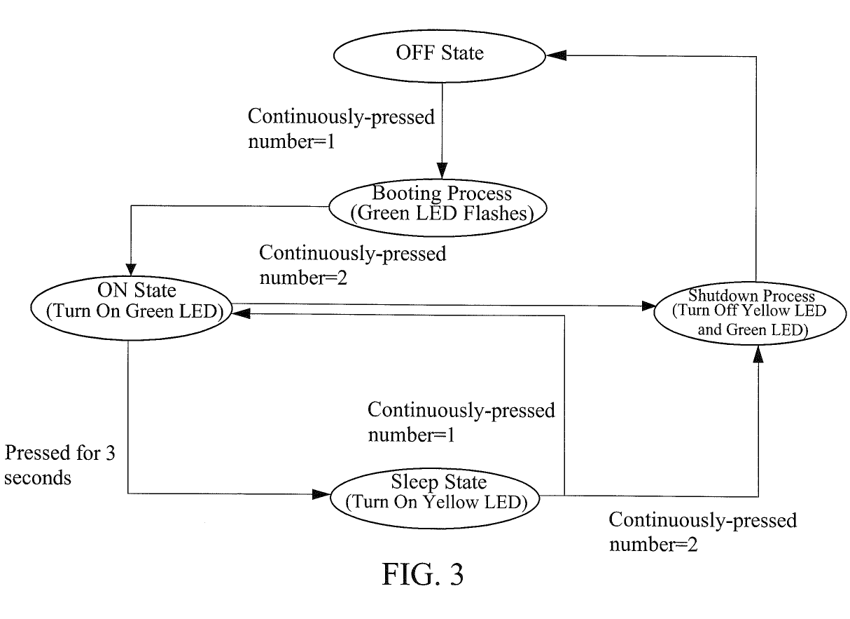

Please refer to FIG. 3. FIG. 3 is a flowchart illustrating a method for controlling a state machine of a camera according to a second embodiment of the present disclosure. What calls for special attention is that, the method for controlling a state machine of a camera 100 according to a continuously-pressed number of a button 110 of the camera 100 shown in FIG. 3 is the same as the method shown in FIG. 2, and thus similar descriptions are omitted here for brevity. The major difference between FIG. 3 and FIG. 2 is that: LED controlling is further added in FIG. 3. As shown in FIG. 3, when the camera 100 is performing the booting process, the processor 120 will control a green LED (such as, the LED 130) of the camera 100 to flash. Additionally, when the state machine of the camera 100 is in the ON state, the processor 120 will turn on a green LED 130 of the camera 100. In this embodiment, when the state machine of the camera 100 is in the sleep state, the processor 120 will turn on a yellow LED (such as, the LED 130) of the camera 100. When the camera 100 is performing the shutdown process, the processor 120 will turn off the green LED and the yellow LED of the camera 100. Be noted that, the green LED and the yellow LED are merely one embodiment of the present disclosure, and should not be a limitation of the present disclosure. Anything that have luminous effect and indicative function should fall within the scope of the present disclosure

The advantage of the present disclosure is that the state machine of the camera can be controlled by using the continuously-pressed number of the button of the camera. Additionally, by using and controlling the LED(s) to collocate with the method, the state machine of the camera can be clearly known by the user so as to provide more convenient manipulation.

Those skilled in the art will readily observe that numerous modifications and alterations of the device and method may be made while retaining the teachings of the invention.

What is claimed is:

1. A method for controlling a state machine of a camera, comprising:
controlling the state machine of the camera according to a continuously-pressed number of a button of the camera;
when the state machine of the camera is in an OFF state and the continuously-pressed number of the button is one, performing a booting process to make the state machine of the camera to be switched from the OFF state into an ON state; and
when the state machine of the camera is in the ON state and the continuously-pressed number of the button is two, performing a shutdown process to make the state machine of the camera to be switched from the ON state into the OFF state.

2. The method according to claim 1, further comprising:
when the state machine of the camera is in the ON state, and the continuously-pressed number of the button is one and the button is pressed for 3 seconds, making the state machine of the camera to be switched from the ON state into a sleep state.

3. The method according to claim 2, further comprising:
when the state machine of the camera is in the sleep state and the continuously-pressed number of the button is one, making the state machine of the camera to be switched from the sleep state into the ON state.

4. The method according to claim 2, further comprising:
when the state machine of the camera is in the sleep state and the continuously-pressed number of the button is two, performing the shutdown process to make the state machine of the camera to be switched from the sleep state into the OFF state.

5. The method according to claim 1, further comprising:
when the camera is performing the booting process, controlling a green LED of the camera to flash.

6. The method according to claim 1, further comprising:
when the state machine of the camera is in the ON state, turning on a green LED of the camera.

7. The method according to claim 2, further comprising:
when the state machine of the camera is in the sleep state, turning on a yellow LED of the camera.

8. The method according to claim 1, further comprising:
when the camera is performing the shutdown process, turning off a green LED and a yellow LED of the camera.

9. A camera capable of controlling a state machine, comprising:
a button; and
a processor, configured for:
controlling the state machine of the camera according to a continuously-pressed number of the button of the camera;
when the state machine of the camera is in an OFF state and the continuously-pressed number of the button is one, performing a booting process to make the state machine of the camera to be switched from the OFF state into an ON state; and
when the state machine of the camera is in the ON state and the continuously-pressed number of the button is two, performing a shutdown process to make the state machine of the camera to be switched from the ON state into the OFF state.

10. The camera according to claim 9, wherein the processor is further configured for:
making the state machine of the camera to be switched from the ON state into a sleep state when the state machine of the camera is in the ON state, and the continuously-pressed number of the button is one and the button is pressed for 3 seconds.

11. The camera according to claim 10, wherein the processor is further configured for:
making the state machine of the camera to be switched from the sleep state into the ON state when the state machine of the camera is in the sleep state and the continuously-pressed number of the button is one.

12. The camera according to claim 10, wherein the processor is further configured for:
performing the shutdown process to make the state machine of the camera to be switched from the sleep state into the OFF state when the state machine of the camera is in the sleep state and the continuously-pressed number of the button is two.

13. The camera according to claim 9, wherein the camera further comprises a green LED and the processor is further configured for:
when the camera is performing the booting process, controlling the green LED to flash.

14. The camera according to claim 9, wherein the camera further comprises a green LED and the processor is further configured for:
when the state machine of the camera is in the ON state, turning on the green LED.

15. The camera according to claim 10, wherein the camera further comprises a yellow LED and the processor is further configured for:
when the state machine of the camera is in the sleep state, turning on the yellow LED.

16. The camera according to claim 9, wherein the camera further comprises a green LED and the processor is further configured for:
when the camera is performing the shutdown process, turning off the green LED.
